(19) United States
(12) Patent Application Publication
(10) Pub. No.: US 2023/0135109 A1
(43) Pub. Date: May 4, 2023

(54) METHOD FOR PROCESSING SIGNAL, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Tianyi Wu, Beijing (CN); Sitong Wu, Beijing (CN); Guodong Guo, Beijing (CN)

(73) Assignee: BEIJING BAIDU NETCOM SCIENCE TECHNOLOGY CO., LTD., Beijing (CN)

(21) Appl. No.: 18/050,672

(22) Filed: Oct. 28, 2022

(30) Foreign Application Priority Data
Oct. 29, 2021 (CN) 202111272720.0

(51) Int. Cl. G06K 9/62

(52) U.S. Cl. CPC G06K 9/6261; G06K 9/6228

(57) ABSTRACT

A method for processing a signal includes: in response to receiving an input feature map of the signal, dividing the input feature map into patches of a plurality of rows and patches of a plurality of columns, in which the input feature map represents features of the signal; selecting a row subset from the plurality of rows and a column subset from the plurality of columns, in which rows in the row subset are at least one row apart from each other, and columns in the column subset are at least one column apart from each other; and obtaining aggregated features by performing self-attention calculation on patches of the row subset and patches of the column subset.

### CROSS-REFERENCE TO RELATED APPLICATION

This application claims priority to Chinese Patent Application No. 202111272720.X filed on Oct. 29, 2021, the entire content of which is incorporated herein by reference.

### TECHNICAL FIELD

The disclosure relates to the field of artificial intelligence (AI) technologies, especially to the field of deep learning and computer vision technologies, in particular to a method for processing a signal, an electronic device, and a computer-readable storage medium.

### BACKGROUND

With the rapid development of AI technologies, computer vision plays an important role in AI systems. Computer vision aims to recognize and understand images/content in images and to obtain three-dimensional information of a scene by processing images or videos collected.

### SUMMARY

According to a first aspect of the disclosure, a method for processing a signal is provided. The method includes: in response to receiving an input feature map of the signal, dividing the input feature map into patches of a plurality of rows and patches of a plurality of columns, in which the input feature map represents features of the signal; selecting a row subset from the plurality of rows and a column subset from the plurality of columns, in which rows in the row subset are at least one row apart from each other, and columns in the column subset are at least one column apart from each other; and obtaining aggregated features by performing self-attention calculation on patches of the row subset and patches of the column subset.

According to a second aspect of the disclosure, an electronic device is provided. The electronic device includes: one or more processors and a storage device for storing one or more programs. When the one or more programs are executed by the one or more processors, the one or more processors are caused to implement the method according to the first aspect of the disclosure.

According to a third aspect of the disclosure, a computer-readable storage medium having computer programs stored thereon is provided. When the computer programs are executed by a processor, the method according to the first aspect of the disclosure is implemented.

### BRIEF DESCRIPTION OF THE DRAWINGS

The accompanying drawings are used to better understand the solutions, and do not constitute a limitation to the disclosure. The above and additional features, advantages and aspects of various embodiments of the disclosure will become more apparent when taken in combination with the accompanying drawings and with reference to the following detailed description. In the drawings, the same or similar figure numbers refer to the same or similar elements, in which:

FIG. 1 is a schematic diagram of an example environment in which various embodiments of the disclosure can be implemented.

FIG. 2 is a flowchart of a method for processing a signal according to some embodiments of the disclosure.

FIG. 3 is a schematic diagram of a self-attention manner according to some embodiments of the disclosure.

FIG. 4 is a flowchart of a method for generating a first-scale feature map according to some embodiments of the disclosure.

FIG. 5 is a schematic diagram of a method for processing a signal based on a self-attention mechanism according to some embodiments of the disclosure.

FIG. 6 is a schematic diagram of an apparatus for processing a signal according to some embodiments of the disclosure.

FIG. 7 is a schematic diagram of an apparatus for processing a signal based on a self-attention mechanism according to some embodiments of the disclosure.

FIG. 8 is a schematic diagram of an apparatus for processing a signal based on a self-attention mechanism according to some embodiments of the disclosure.

FIG. 9 is a block diagram of a computing device capable of implementing embodiments of the disclosure.

### DETAILED DESCRIPTION

The following describes embodiments of the disclosure with reference to the accompanying drawings, which includes various details of embodiments of the disclosure to facilitate understanding and shall be considered merely exemplary. Therefore, those of ordinary skill in the art should recognize that various changes and modifications can be made to embodiments described herein without departing from the scope and spirit of the disclosure. For clarity and conciseness, descriptions of well-known functions and structures are omitted in the following description.

In the description of embodiments of the disclosure, the term “including” and the like should be understood as open inclusion, i.e., “including but not limited to”. The term “based on” should be understood as “based at least partially on”. The term “some embodiments” or “an embodiment” should be understood as “at least one embodiment”. The terms “first”, “second”, and the like may refer to different or the same objects. Other explicit and implicit definitions may also be included below.

As mentioned above, in the existing backbone network for solving computer vision tasks, there are problems such as high computation complexity and insufficient context modeling. Self-attention networks (transformers) are increasingly used in such backbone networks. Self-attention network is shown to be a simple and scalable framework for computer vision tasks such as image recognition, classification and segmentation, or for simply learning global image representations. Currently, self-attention networks are increasingly applied to computer vision tasks, to reduce structural complexity, and explore scalability and training efficiency.

Self-attention sometimes is called internal attention, which is an attention mechanism associated with different positions in a single sequence. Self-attention is the core content of the self-attention network, which can be understood as queues and a set of values are corresponding to the input, that is, mapping of queries, keys and values to output, in which the output can be regarded as a weighted sum of the values, and the weighted value is obtained by self-attention.

Currently, there are three main types of self-attention mechanism in the backbone network of the self-attention network.

The first type of self-attention mechanism is global self-attention. This scheme divides an image into multiple patches, and then performs self-attention calculation on all the patches, to obtain the global context information.

The second type of self-attention mechanism is sparse self-attention. This scheme reduces the amount of computation by reducing the number of keys in self-attention, which is equivalent to sparse global self-attention.

The third type of self-attention mechanism is local self-attention. This scheme restricts the self-attention area locally and introduces across-window feature fusion.

The first type can obtain a global receptive field. However, since each patch needs to establish relations with all other patches, this type requires a large amount of training data and usually has a high computation complexity.

The sparse self-attention manner turns dense connections among patches into sparse connections to reduce the computation amount, but it leads to information loss and confusion, and relies on rich-semantic high-level features.

The third type only performs attention-based information transfer among patches in a local window. Although it can greatly reduce the amount of calculation, it will also lead to a reduced receptive field and insufficient context modeling. To address this problem, a known solution is to alternately use two different window division manners in adjacent layers to enable information to be transferred between different windows. Another known solution is to change the window shape into one row and one column or adjacent multiple rows and multiple columns to increase the receptive field. Although such manners reduce the amount of computation to a certain extent, their context dependencies are not rich enough to capture sufficient context information in a single self-attention layer, thereby limiting the modeling ability of the entire network.

In order to solve at least some of the above problems, embodiments of the disclosure provide an improved solution. The solution includes: in response to receiving an input feature map of the signal, dividing the input feature map into patches of a plurality of rows and patches of a plurality of columns, in which the input feature map represents features of the signal; selecting a row subset from the plurality of rows and a column subset from the plurality of columns, in which rows in the row subset are at least one row apart from each other, and columns in the column subset are at least one column apart from each other; and obtaining aggregated features by performing self-attention calculation on patches of the row subset and patches of the column subset. In this way, the solution of embodiments of the disclosure can greatly reduce the amount of calculation compared with the global self-attention manner. Compared to the sparse self-attention manner, the disclosed solution reduces information loss and confusion during the aggregation process. Compared to the local self-attention manner, the disclosed solution can capture richer contextual information with similar computation complexity.

In embodiments of the disclosure, image signal processing is used as an example for introduction. However, the solution of the disclosure is not limited to image processing, but can be applied to other various processing objects, such as, speech signals and text signals.

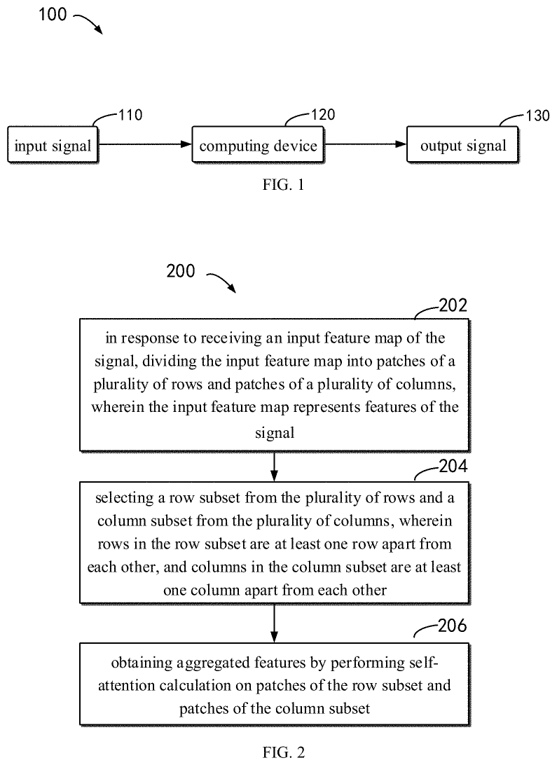

Embodiments of the disclosure will be described in detail below with reference to the accompanying drawings. FIG. 1 is a schematic diagram of an example environment 100 in which various embodiments of the disclosure can be implemented. As illustrated in FIG. 1, the example environment 100 includes an input signal 110, a computing device 120, and an output signal 130 generated via the computing device 120.

In some embodiments, the input signal 110 may be an image signal. For example, the input signal 110 may be an image stored locally on the computing device, or may be an externally input image, e.g., an image downloaded from the Internet. In some embodiments, the computing device 120 may also be external to an image acquisition device to acquire images. The computing device 120 processes the input signal 110 to generate the output signal 130.

In some embodiments, the computing device 120 may include, but not limited to, personal computers, server computers, handheld or laptop devices, mobile devices (such as mobile phone, personal digital assistant (PDA), and media player), consumer electronic products, minicomputers, mainframe computers, cloud computing resources, or the like.

It should be understood that the structure and function of the example environment 100 are described for exemplary purposes only and are not intended to limit the scope of the subject matter described herein. The subject matter described herein may be implemented in different structures and/or functions.

The technical solutions described above are only used for example, rather than limiting the disclosure. It should be understood that the example environment 100 may also have a variety of other ways. In order to more clearly explain the principles of the disclosure, the process of processing the signal will be described in more detail below with reference to FIG. 2.

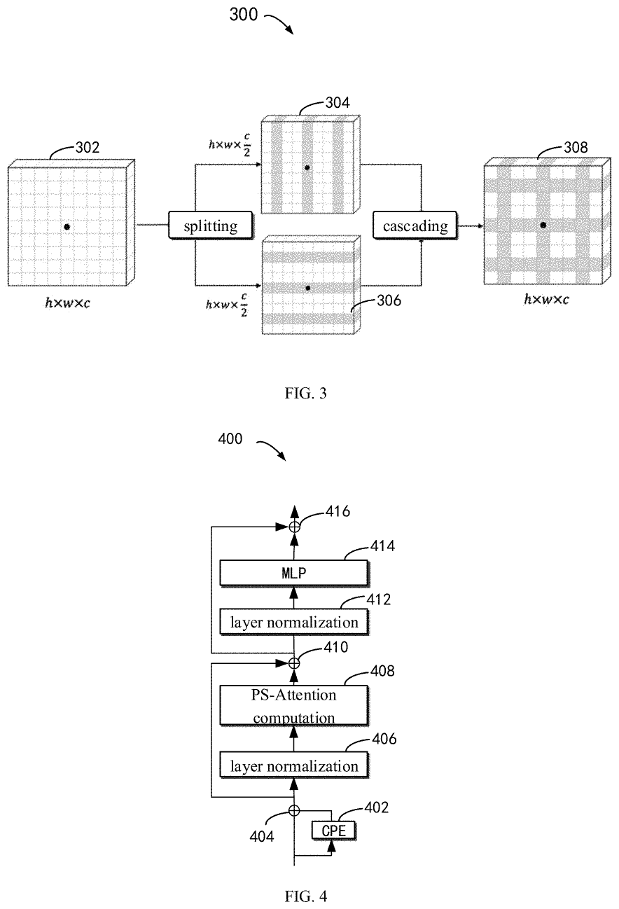

FIG. 2 is a flowchart of a method for processing a signal according to some embodiments of the disclosure. In some embodiments, the signal processing process 200 may be implemented in the computing device 120 of FIG. 1. As illustrated in FIG. 2 and in combination with FIGS. 1 and 3, the signal processing process 200 according to some embodiments of the disclosure will be described. For ease of understanding, the specific examples mentioned in the following description are all illustrative, and are not intended to limit the protection scope of the disclosure.

At block 202, the computing device 120 divides the input feature map 302 (e.g., the feature map of the input signal 110) into patches of a plurality of rows and patches of a plurality of columns, in response to receiving the input feature map 302, in which the input feature map represents features of the signal. In some embodiments, the input feature map 302 is a feature map of an image, and the feature map represents features of the image. In some embodiments, the input feature map 302 may be a feature map of other signal, e.g., a speech signal or text signal. In some embodiments, the input feature map 302 may be features (e.g., features of the image) obtained by preprocessing the input signal (e.g., the image) through a neural network. In some embodiments, the input feature map 302 generally is a rectangular. The input feature map 302 may be divided into a corresponding number of rows and a corresponding number of columns according to the size of the input feature map 302, to ensure that the feature map is divided into a plurality of complete rows and a plurality of complete columns, thereby avoiding padding.

In some embodiments, the rows have the same size and the columns have the same size. The mode of dividing the plurality of rows and the plurality of columns in the above embodiments is only exemplary, and embodiments of the disclosure are not limited to the above modes, and there may be various modification modes. For example, the size of the rows may not be the same, and rows of different sizes may be involved, or the size of the columns may not be the same, and columns of different sizes may be involved.

In some embodiments, the input feature map 302 is divided into a first feature map 306 and a second feature map 304 that are independent of each other in a channel dimension. The first feature map 306 is divided into the plurality of columns, and the second feature map 304 is divided into the plurality of rows. For example, in some embodiments, it is given an input feature map X∈R^{h×w×c}, which can be divided into two independent parts

$${X}_{r} ∈ {R}^{h \times w \times \frac{c}{2}} and {X}_{c} ∈ {R}^{h \times w \times \frac{c}{2}} ,$$

and then Xᵣ and X_{c} are divided into the plurality of groups respectively, as follows:

Xᵣ=[Xᵣ¹, . . . ,Xᵣ^{N}^{ᵣ}], X_{c}=[X_{c}¹, . . . ,X_{c}^{N}^{_{c}}] (1)

where:

Xᵣ is a vector matrix, representing a matrix of vectors corresponding to patches of the first feature map 306;

Xᵣ¹ represents a vector corresponding to patches of the first row (the spaced row) of the first feature map 306;

Xᵣ^{N}^{ᵣ} represents a vector corresponding to patches of the Nr^{th} row of the first feature map 306;

that is, Xᵣ includes groups such as Xᵣ¹, . . . , Xᵣ^{N}^{ᵣ};

X_{c} is a vector matrix, representing a matrix of vectors corresponding to patches of the second feature map 304;

X_{c}¹ represents a vector corresponding to patches of the first column (the spaced column) of the second feature map 304;

X_{c}^{N}^{_{c}} represents a vector corresponding to patches of the Nc^{th} column of the second feature map 304;

that is, X_{c} includes groups such as X_{c}¹, . . . , X_{c}^{N}^{_{c}};

Nᵣ=h/sᵣ, N_{c}=w/s_{c}, Xᵣⁱ∈R^{s}^{ᵣ}^{×w×c} and X_{c}^{j}∈R^{h×s}^{ᵣ}^{×c}, in which h is the height of the input feature map 302, w the width of the input feature map 302, sᵣ is the number of spaced rows (i.e., rows in the row subset), and s_{c} is the number of spaced columns (i.e., columns in the column subset). Xᵣⁱ represents a vector corresponding to patches of the i^{th} row (the spaced row) of the first feature map 306. X_{c}^{j} represents a vector corresponding to patches of the j^{th} column (the spaced column) of the second feature map 304. R is the real number and c is the dimension of the vectors.

In this way, in some embodiments, it is only necessary to ensure that h is divisible by sᵣ and w is divisible by s_{c}, thereby avoiding padding.

Through this division mode, the self-attention computation can be decomposed into row-wise self-attention computation and column-wise self-attention computation, which is described in detail below.

In some embodiments, the input feature map is received, and space downsampling is performed on the input feature map to obtain a downsampled feature map. In this way, the image can be reduced, that is, a thumbnail of the image can be generated, so that the dimensionality of the features can be reduced and valid information is preserved. In this way, overfitting can be avoided to a certain extent, and rotation, translation, and expansion and contraction can be maintained without deformation.

At block 204, a row subset is selected from the plurality of rows and a column subset is selected from the plurality of columns, in which rows in the row subset are at least one row apart from each other, and columns in the column subset are at least one column apart from each other. In some embodiments, the rows of the row subset may be spaced at an equal distance, such as, one row, two rows, or more rows. The columns of the column subset can be spaced at an equal distance, such as, one column, two columns, or more columns.

In some embodiments, a plurality of pales is determined from the row subset and the column subset, in which each pale includes at least one row in the row subset and at least one column in the column subset. For example, reference may be made to the aggregated feature map 308 in FIG. 3. The shaded portion shown in the aggregated feature map 308 constitutes a pale. In some embodiments, a pale may consist of row(s) in the row subset and column(s) in the column subset. For example, in some embodiments, a pale may consist of sᵣ spaced rows (i.e., the rows in the row subset) and s_{c} spaced columns (i.e., the columns in the column subset), where sᵣ and s_{c} are integers greater than 1. Therefore, each pale contains (sᵣw+s_{c}h−sᵣs_{c}) patches, sᵣw is the number of patches on each row, and s_{c}h is the number of patches on each column, and sᵣs_{c} is the number of squares where rows and columns are intersected in the pale. A square can represent a point on the feature map. w is the width of the pale and h is the height of the pale. In some embodiments, the size (width and length) of the feature map may be equal to the size of the pale. In some embodiments, (sᵣ, s_{c}) may be defined as the size of the pale. Given the input feature map X∈R^{h×w×c}, where R is the real number, h is the height of the pale, w is the width of the pale, and c is the dimension. The dimensions may be, for example, 128, 256, 512, and 1024. In some embodiments, the input feature map may be divided into multiple pales of the same size {P₁, . . . , P_{N}}, where Pᵢ∈R^{(s}^{ᵣ}^{w+s}^{_{c}}^{h-s}^{ᵣ}^{s}^{_{c}}^{)×c}, i∈{1,2, . . . , N}, and the number of pales is N=h/sᵣ=w/s_{c}. For all the pales, the spacing between adjacent rows or columns in the pale may be the same or different. In some embodiments, the self-attention computation may be performed separately on the patches corresponding to the rows and the patches corresponding to the columns within each pale. In this way, the amount of computation is greatly reduced compared to the global self-attention manner. Moreover, compared with the local self-attention manner, the pale self-attention (PS-Attention) network has a larger receptive field and can capture richer context information.

At block 206, the computing device 120 performs self-attention computation on patches corresponding to the row subset and patches corresponding to the column subset, to obtain the aggregated features of the signal. In some embodiments, performing the self-attention calculation on the patches of the row subset and the patches of the column subset includes: performing the self-attention calculation on patches of each of the pales, to obtain sub-aggregated features; and cascading the sub-aggregated features, to obtain the aggregated features.

As illustrated in FIG. 3, FIG. 3 is a schematic diagram of a self-attention manner according to some embodiments of the disclosure. As illustrated in FIG. 3, in the process 300, the input feature map 302 is divided into the first feature map 306 and the second feature map 304 that are independent of each other in the channel dimension. The first feature map 306 is divided into multiple columns, and the second feature map 304 is divided into multiple rows. In some embodiments, self-attention calculation is performed on the patches corresponding to the row subset and the patches corresponding to the column subset are respectively. The calculation includes: performing the self-attention calculation on the row subset of the first feature map 306 and the column subset of the second feature map 304 respectively, to obtain first sub-aggregated features and second sub-aggregated features; and cascading the first sub-aggregated features and the second sub-aggregated features in the channel dimension to generate the aggregated features. In this way, the input feature map 302 is divided into the first feature map 306 and the second feature map 304 that are independent of each other in the channel dimension, and the first feature map 306 and the second feature map 304 are further divided into groups. Then the self-attention calculation is performed on the groups in the row direction and the groups in the column direction in parallel. This self-attention mechanism can further reduce the computation complexity.

In some embodiments, performing the self-attention calculation on the row subset of the first feature map and the column subset of the second feature map respectively includes: dividing the row subset of the first feature map into a plurality of row groups, each row group containing at least one row; dividing the column subset of the second feature map into a plurality of column groups, each column group containing at least one column, in which the above manner is as described as formula (1), Xᵣ includes groups Xᵣ¹, . . . , Xᵣ^{N}^{ᵣ}, and X_{c} includes groups X_{c}¹, . . . , X_{c}^{N}^{_{c}}; performing the self-attention calculation on patches of each row group and patches of each column group respectively, to obtain aggregated row features and aggregated column features; and cascading the aggregated row features with the aggregated column features in the channel dimension, to obtain the aggregated features. In this way, by performing self-attention calculation on each row group in the first feature map and each column group in the second feature map respectively, the amount of calculation can be reduced and the calculation efficiency can be improved.

In some embodiments, performing the self-attention calculation on the patches of each row group and the patches of each column group includes respectively: determining a first matrix, a second matrix, and a third matrix of each row group and a first matrix, a second matrix, and a third matrix of each column group, in which the first matrix, the second matrix, and the third matrix are configured to generate a query, a key and a value of each row group or each column group; and performing multi-headed self-attention calculation on the first matrix, the second matrix, and the third matrix of each row group, and the first matrix, the second matrix, and the third matrix of each column group respectively. In this way, by performing corresponding operations on the matrix of each row group and each column group, the computation efficiency can be improved.

In some embodiments, the self-attention computation is performed separately on the groups in the row direction and the groups in the column direction, and the formulas are provided as follows:

Yᵣⁱ=MSA(ϕ_{Q}(Xᵣⁱ),ϕ_{K}(Xᵣⁱ),ϕ_{V}(Xᵣⁱ))

Y_{c}ⁱ=MSA(ϕ_{Q}(X_{c}ⁱ),ϕ_{K}(X_{c}ⁱ),ϕ_{V}(X_{c}ⁱ)) (2)

As described above, Xᵣⁱ represents a vector corresponding to the patches of the i^{th} row of the first feature map 306, X_{c}ⁱ, represents a vector corresponding to the patches of the i^{th} column of the second feature map 304, ϕ_{Q}, ϕ_{K} and ϕ_{V} are the first matrix, second matrix, and third matrix respectively, which represent a query, a key and a value of matrix. ϕ_{Q}, ϕ_{K} and ϕ_{V} in embodiments of the disclosure are not limited to represent a query, a key and a value of matrix, and other matrices may also be used in some embodiments. i∈{1, 2, . . . , N}, in which MSA means performing the multi-head self-attention computation on the above matrix. Yᵣⁱ represents the result obtained by performing the multi-head self-attention calculation on the vectors in the row direction (r direction), and Y_{c}ⁱ represents the result obtained by performing the multi-head self-attention calculation on the vectors in the above column direction (c direction). The self-attention output of the row direction and that of the column direction are cascaded in the channel dimension to obtain the final output Y∈R^{h×w×c}. In some embodiments, when the multi-head self-attention calculation is performed, ϕ_{Q} and ϕ_{K} are multiplied, and then normalization processing is performed, and the result of the normalization processing is multiplied by ϕ_{V}.

The self-attention output of the row direction and that of the column direction are cascaded in the channel dimension to obtain the final output Y∈R^{h×w×c}.

Y=Concat(Yᵣ,Y_{c}) (3)

Yᵣ represents a sum of the multi-head self-attention calculation performed on the vectors in all row directions, and Y_{c} represents a sum of the multi-head self-attention calculation performed on the vectors in all row directions. Concat means cascading Yᵣ and Y_{c}, that is, Yᵣ and Y_{c} are combined in the space dimension. Y represents the result of the cascading. The above embodiments can reduce the complexity of self-attention calculation. The complexity analysis is provided as follows.

Assuming that the input feature resolution is h×w×c and the pale size is (sᵣ, s_{c}).

The complexity of the global self-attention computation is:

ο_{Global}=4hwc²+2c(hw)² (4)

ο_{Global} represents the complexity of the global self-attention computation, and the meanings of the remaining parameters are as described above.

The complexity of the PS-Attention computation is:

ο_{Pale}=4hwc²+hwc(s_{c}h+sᵣw+27)<<ο_{Global} (5)

ο_{Pale} represents the computation complexity of the PS-Attention method, and the meanings of the remaining parameters are as described above.

It can be seen that the complexity of the self-attention computation in embodiments of the disclosure is significantly lower than that of the global self-attention computation.

It should be understood that the self-attention mechanism of the disclosure is not limited to the specific embodiments described above in combination with the accompanying drawings, but may have many variations that can be easily conceived by those of ordinary skill in the art based on the above examples.

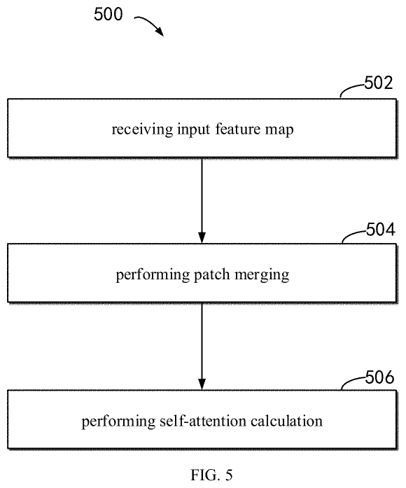

FIG. 4 is a flowchart of a method for generating a first-scale feature map according to some embodiments of the disclosure. As illustrated in FIG. 4, in the process 400, in some embodiments, at block 402, conditional position encoding (CPE) is performed on the downsampled feature map, to generate an encoded feature map. In this way, the locations of the features can be obtained more accurately. In some embodiments, the input feature map is down-sampled to obtain the downsampled feature map. In some embodiments, performing CPE on the downsampled feature map includes: performing depthwise convolution computation on the downsampled feature map, to generate the encoded feature map. In this way, the encoded feature map can be generated quickly. At block 404, the downsampled feature map is added to the encoded feature map, to generate first feature vectors. At block 406, layer normalization is performed on the first feature vectors to generate first normalized feature vectors. At block 408, self-attention calculation is performed on the first normalized feature vectors, to generate second feature vectors. At block 410, the first feature vectors and the second feature vectors are added to generate third feature vectors. At block 412, layer normalization process is performed on the third feature vectors to generate second normalized feature vectors. At block 414, multi-layer perceptron (MLP) calculation is performed on the second normalized feature vectors to generate fourth feature vectors. At block 416, the second layer normalized feature vectors are added to the fourth feature vectors to generate a first-scale feature map. In this way, the capability and performance of feature learning on the input feature map can be improved.

FIG. 5 is a schematic diagram of a method for processing a signal based on self-attention according to some embodiments of the disclosure. As illustrated in FIG. 5, in the process 500, at block 502, an input feature map is received. At block 504, patch merging process is performed on the input feature map. In some embodiments, the feature map can be spatially down-sampled by performing the patch merging process on the input feature map, and the channel dimension can be enlarged, for example, by a factor of 2. In some embodiments, a 7×7 convolution with 4 strides can be used to achieve 4× downsampling. In some embodiments, 2× downsampling can be achieved using 3×3 convolution with 2 strides. At block 506, self-attention computation is performed on the features after performing the patch merging processing to generate the first-scale feature map. The self-attention calculation performed on the features after the patch merging processing can be performed using the method for generating the first-scale feature map as described above with respect to FIG. 4, which will not be repeated herein.

In some embodiments, the first-scale feature map can be used as the input feature map, and the steps of spatially down-sampling the input feature map and generating variable-scale features are repeatedly performed, in each repetition cycle, the step of performing the space downsampling is performed once and the step of generating the variable-scale features is performed at least once. Experiments show that in this way, the quality of the output feature map can be further improved.

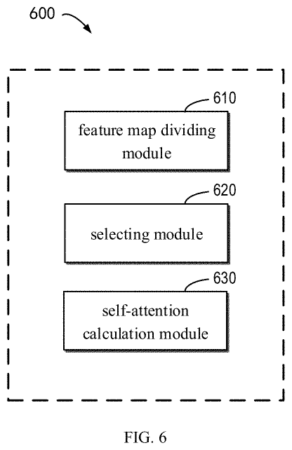

FIG. 6 is a schematic diagram of an apparatus for processing a signal according to some embodiments of the disclosure (the method in the block diagram of FIG. 1). As illustrated in FIG. 6, the apparatus 600 includes: a feature map dividing module 610, a selecting module 620 and a self-attention calculation module 630. The feature map dividing module 610 is configured, in response to receiving an input feature map of the signal, divide the input feature map into patches of a plurality of rows and patches of a plurality of columns, in which the input feature map represents features of the signal. The selecting module 620 is configured to select a row subset from the plurality of rows and a column subset from the plurality of columns, in which rows in the row subset are at least one row apart from each other, and columns in the column subset are at least one column apart from each other. The self-attention calculation module 630 is configured to obtain aggregated features by performing self-attention calculation on patches of the row subset and patches of the column subset.

In some embodiments, the feature map dividing module includes: a pale determining module, configured to determine a plurality of pales from the row subset and the column subset, in which each of the pales includes at least one row in the row subset and at least one column in the column subset.

In some embodiments, the self-attention calculation module includes: a first self-attention calculation sub-module and a first cascading module. The first self-attention calculation sub-module is configured to perform the self-attention calculation on patches of each of the plurality of pales, to obtain sub-aggregated features. The first cascading module is configured to cascade the sub-aggregated features, to obtain the aggregated features.

In some embodiments, the feature map dividing module further includes: a feature map splitting module and a row and column dividing module. The feature map splitting module is configured to divide the input feature map into a first feature map and a second feature map that are independent of each other in a channel dimension. The row and column dividing module is configured to divide the first feature map into the plurality of rows, and divide the second feature map into the plurality of columns.

In some embodiments, the self-attention calculation module further includes: a second self-attention calculation sub-module and a second cascading module. The second self-attention calculation sub-module is configured to perform the self-attention calculation on the row subset of the first feature map and the column subset of the second feature map respectively, to obtain first sub-aggregated features and second sub-aggregated features. The second cascading module is configured to cascade the first sub-aggregated features and the second sub-aggregated features in the channel dimension to generate the aggregated features.

In some embodiments, the second self-attention calculation sub-module includes: a row group dividing module, a column group dividing module, a row group and column group self-attention calculation unit and a row group and column group cascading unit. The row group dividing module is configured to divide the row subset of the first feature map into a plurality of row groups, each row group containing at least one row. The column group dividing module is configured to divide the column subset of the second feature map into a plurality of column groups, each column group containing at least one column. The row group and column group self-attention calculation unit is configured to perform the self-attention calculation on patches of each row group and patches of each column group respectively, to obtain aggregated row features and aggregated column features. The row group and column group cascading unit is configured to cascade the aggregated row features and the aggregated column features in the channel dimension, to obtain the aggregated features.

In some embodiments, the row group and column group self-attention calculation unit includes: a matrix determining unit and a multi-headed self-attention calculation unit. The matrix determining unit is configured to determine a first matrix, a second matrix, and a third matrix of each row group and a first matrix, a second matrix, and a third matrix of each column group, in which the first matrix, the second matrix, and the third matrix are configured to generate a query, a key and a value of each row group or each column group. The multi-headed self-attention calculation unit is configured to perform multi-headed self-attention calculation on the first matrix, the second matrix, and the third matrix of each row group, and the first matrix, the second matrix, and the third matrix of each column group respectively.

In some embodiments, the apparatus further includes: a downsampling module, configured to perform space downsampling on the input feature map, to obtain a downsampled feature map.

In some embodiments, the apparatus further includes: a CPE module, configured to perform CPE on the downsampled feature map, to generate an encoded feature map.

In some embodiments, the CPE module is further configured to perform depthwise convolution calculation on the downsampled feature map.

In some embodiments, the apparatus includes a plurality of stages connected in series, each stage includes the CPE module and at least one variable scale feature generating module. The at least one variable scale feature generating module includes: a first adding module, a first layer normalization module, a self-attention module, a second adding module, a third feature vector generating module, a MLP module and a third adding module. The first adding module is configured to add the downsampled feature map to the encoded feature map, to generate first feature vectors. The first layer normalization module is configured to perform layer normalization on the first feature vectors, to generate first normalized feature vectors. The self-attention module is configured to perform self-attention calculation on the first normalized feature vectors, to generate second feature vectors. The second adding module is configured to add the first feature vectors with the second feature vectors, to generate third feature vectors. The third feature vector generating module is configured to perform layer normalization on the third feature vectors, to generate second normalized feature vectors. The MLP module is configured to perform MLP calculation on the second normalized feature vectors, to generate fourth feature vectors. The third adding module is configured to add the second normalized feature vectors to the fourth feature vectors, to generate a first-scale feature map.

In some embodiment, the apparatus determines the first-scale feature map as the input feature map, and repeats steps of performing the space downsampling on the input feature map and generating variable-scale features. In each repeating cycle, the step of performing the space downsampling is performed once and the step of generating the variable-scale features is performed at least once.

Through the above embodiments, an apparatus for processing a signal is provided, which can greatly reduce the amount of calculation, reduce the information loss and confusion in the aggregation process, and can capture richer context information with similar computation complexity.

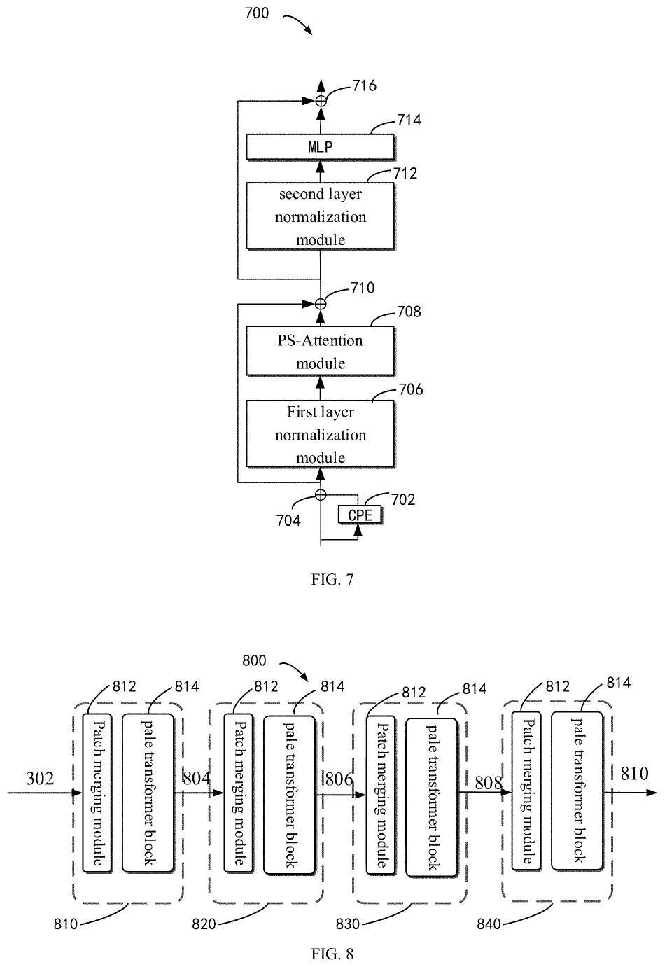

FIG. 7 is a schematic diagram of a processing apparatus based on a self-attention mechanism according to the disclosure. As illustrated in FIG. 7, the processing apparatus 700 includes a CPE 702, a first adding module 704, a first layer normalization module 706, a PS-Attention module 708, a second adding module 710, a second layer normalization module 712, a Multilayer Perceptron (MLP) 714 and a third adding module 716. The first adding module 704 is configured to add the downsampled feature map to the encoded feature map, to generate first feature vectors. The first layer normalization module 706 is configured to perform layer normalization on the first feature vectors, to generate first normalized feature vectors. The PS-Attention module 708 is configured to perform self-attention calculation on the first normalized feature vectors, to generate second feature vectors. The second adding module 710 is configured to add the first feature vectors with the second feature vectors, to generate third feature vectors. The third feature vector generating module 712 is configured to perform layer normalization on the third feature vectors, to generate second normalized feature vectors. The MLP 714 is configured to perform MLP calculation on the second normalized feature vectors, to generate fourth feature vectors. The third adding module 716 is configured to add the second normalized feature vectors to the fourth feature vectors, to generate a first-scale feature map. In this way, the capability and performance of feature learning on the input feature map can be improved.

FIG. 8 is a schematic diagram of an apparatus for processing a signal based on a self-attention mechanism according to some embodiments of the disclosure. As illustrated in FIG. 8, the apparatus 800 based on the self-attention mechanism may be a general visual self-attention backbone network, which may be called a pale transformer. In the embodiment shown in FIG. 8, the pale transformer contains 4 stages. The embodiments of the disclosure are not limited to adopting 4 stages, and other numbers of stages are possible. For example, one stage, two stages, three stages, . . . , N stages may be employed, where N is a positive integer. In this system, each stage can correspondingly generate features with one scale. In some embodiments, multi-scale features are generated using a hierarchical structure with multiple stages. Each stage consists of a patch merging layer and at least one pale transformer block.

The patch merging layer has two main roles: (1) downsampling the feature map in space, (2) expanding the channel dimension by a factor of 2. In some embodiments, a 7×7 convolution with 2 strides is used for 4×downsampling and a 3×3 convolution with 4 strides is used for 2×downsampling. The parameters of the convolution kernel are learnable and vary according to different inputs.

The pale transformer block consists of three parts: CPE module, PS-Attention module and MLP module. The CPE module computes the positions of features. The PS-Attention module is configured to perform self-attention calculation on CPE vectors. The MLP module contains two linear layers for expanding and contracting the channel dimension respectively. The forward calculation process of the first block is as follows:

\tilde{X}^{l}=X^{l-1}+CPE(X^{l-1})

\hat{X}^{l}=\tilde{X}^{l}+PS-Attention(LN(\tilde{X}^{l}))

X^{l}=\hat{X}^{l}+MLP(LN(\hat{X}^{l})) (6)

CPE represents the CPE function used to obtain the positions of the patches, and l represents the first pale transformer block in the device; X^{l-1} represents the output of the (X^{l-1})^{th} transformer block; \tilde{X}^{l} represents the first result obtained by summing the output of the (X^{l-1})^{th} block and the output after CPE calculation is performed; PS-Attention represents PS-Attention computation; LN represents layer normalization; \hat{X}^{l} represents the second result obtained by summing the first result and PS-Attention(LN(\tilde{X}^{l})); MLP represents MLP function used to map multiple input datasets to a single output dataset; X^{l} represents the result obtained by summing the second result with MLP(LN(\hat{X}^{l}); and CPE can dynamically generate position codes from the input image. In some embodiments, a depthwise convolution is used to dynamically generate the position codes from the input image. In some embodiments, the position codes can be output by inputting the feature map into the convolution.

In some embodiments, one or more PS-Attention blocks may be included in each stage. In some embodiments, 1 PS-Attention block is included in the first stage 810. The second stage 812 includes 2 PS-Attention blocks. The third stage 814 includes 16 PS-Attention blocks. The fourth stage 812 includes 2 PS-Attention blocks.

In some embodiments, after the processing in the first stage 810, the size of the input feature map is reduced, for example, the height is reduced to ¼ of the initial height, the width is reduced to ¼ of the initial width, and the dimension is c. After the processing in the second stage 820, the size of the input feature map is reduced for example, the height is reduced to ⅛ of the initial height, the width is reduced to ⅛ of the initial width, and the dimension is 2c. After the processing in the third stage 830, the size of the input feature map is reduced, for example, the height is reduced to 1/16 of the initial height, the width is reduced to 1/16 of the initial width, and the dimension is 4c. After the processing in the fourth stage 840, the size of the input feature map is reduced, for example, the height is reduced to 1/32 of the initial height, the width is reduced to 1/32 of the initial width, and the dimension is c.

In some embodiments, in the second stage 820, the first-scale feature map output by the first stage 812 is used as the input feature map of the second stage 820, and the same or similar calculation as in the first stage 812 is performed, to generate the second scale feature map. For the N^{th} stage, the (N−1)^{th} scale feature map output by the (N−1)^{th} stage is determined as the input feature map of the N^{th} stage, and the same or similar calculation as previous is performed to generate the N^{th} scale feature map, where N is an integer greater than or equal to 2.

In some embodiments, the signal processing apparatus 800 based on the self-attention mechanism may be a neural network based on the self-attention mechanism.

The solution of the disclosure can effectively improve the feature learning ability and performance of computer vision tasks (e.g., image classification, semantic segmentation and object detection). For example, the amount of computation can be greatly reduced, and information loss and confusion in the aggregation process can be reduced, so that richer context information with similar computation complexity can be collected. The PS-Attention backbone network in the disclosure surpasses other backbone networks of similar model size and amount of computation on three authoritative datasets, ImageNet-1K, ADE20K and COCO.

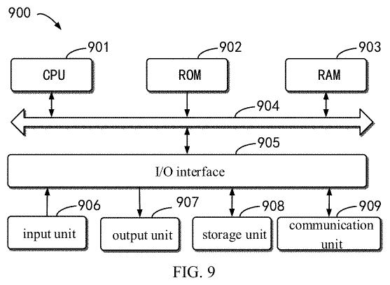

FIG. 9 is a block diagram of a computing device 900 used to implement the embodiments of the disclosure. Electronic devices are intended to represent various forms of digital computers, such as laptop computers, desktop computers, workbenches, PDAs, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 9, the electronic device 900 includes: a computing unit 901 performing various appropriate actions and processes based on computer programs stored in a read-only memory (ROM) 902 or computer programs loaded from the storage unit 908 to a random access memory (RAM) 903. In the RAM 903, various programs and data required for the operation of the device 900 are stored. The computing unit 901, the ROM 902, and the RAM 903 are connected to each other through a bus 904. An input/output (I/O) interface 905 is also connected to the bus 904.

Components in the device 900 are connected to the I/O interface 905, including: an inputting unit 906, such as a keyboard, a mouse; an outputting unit 907, such as various types of displays, speakers; a storage unit 908, such as a disk, an optical disk; and a communication unit 909, such as network cards, modems, and wireless communication transceivers. The communication unit 909 allows the device 900 to exchange information/data with other devices through a computer network such as the Internet and/or various telecommunication networks.

The computing unit 901 may be various general-purpose and/or dedicated processing components with processing and computing capabilities. Some examples of computing unit 901 include, but not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 901 executes the various methods and processes described above, such as processes 200, 300, 400 and 500. For example, in some embodiments, the processes 200, 300, 400 and 500 may be implemented as a computer software program, which is tangibly contained in a machine-readable medium, such as the storage unit 908. In some embodiments, part or all of the computer program may be loaded and/or installed on the device 900 via the ROM 902 and/or the communication unit 909. When the computer program is loaded on the RAM 903 and executed by the computing unit 901, one or more steps of the processes 200, 300, 400 and 500 described above may be executed. Alternatively, in other embodiments, the computing unit 901 may be configured to perform the processes 200, 300, 400 and 500 in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those of ordinary skill in the art should understand that various modifications, combinations, sub-combinations and substitutions can be made according to design requirements and other factors. Any modification, equivalent replacement and improvement made within the spirit and principle of this application shall be included in the protection scope of this application.

1. A method for processing a signal, comprising:
in response to receiving an input feature map of the signal, dividing the input feature map into patches of a plurality of rows and patches of a plurality of columns, wherein the input feature map represents features of the signal;
selecting a row subset from the plurality of rows and a column subset from the plurality of columns, wherein rows in the row subset are at least one row apart from each other, and columns in the column subset are at least one column apart from each other; and
obtaining aggregated features by performing self-attention calculation on patches of the row subset and patches of the column subset.

2. The method of claim 1, wherein, performing the self-attention calculation on the patches of the row subset and the patches of the column subset, comprises:
determining a plurality of pales from the row subset and the column subset, wherein each of the pales comprises at least one row in the row subset and at least one column in the column subset;
performing the self-attention calculation on patches of each of the plurality of pales, to obtain sub-aggregated features; and
cascading the sub-aggregated features, to obtain the aggregated features.

3. The method of claim 1, wherein, dividing the input feature map into the patches of the plurality of rows and the patches of the plurality of columns, comprises:
dividing the input feature map into a first feature map and a second feature map that are independent of each other in a channel dimension; and
dividing the first feature map into the plurality of rows, and dividing the second feature map into the plurality of columns.

4. The method of claim 3, wherein, performing the self-attention calculation on the patches of the row subset and the patches of the column subset, comprises:
performing the self-attention calculation on the row subset of the first feature map and the column subset of the second feature map respectively, to obtain first sub-aggregated features and second sub-aggregated features; and
cascading the first sub-aggregated features and the second sub-aggregated features in the channel dimension to generate the aggregated features.

5. The method of claim 4, wherein, performing the self-attention calculation on the row subset of the first feature map and the column subset of the second feature map respectively, comprises:
dividing the row subset of the first feature map into a plurality of row groups, each row group containing at least one row;
dividing the column subset of the second feature map into a plurality of column groups, each column group containing at least one column;
performing the self-attention calculation on patches of each row group and patches of each column group respectively, to obtain aggregated row features and aggregated column features; and
cascading the aggregated row features and the aggregated column features in the channel dimension, to obtain the aggregated features.

6. The method of claim 5, wherein, performing the self-attention calculation on the patches of each row group and the patches of each column group respectively, comprises:
determining a first matrix, a second matrix, and a third matrix of each row group and a first matrix, a second matrix, and a third matrix of each column group, wherein the first matrix, the second matrix, and the third matrix are configured to generate a query, a key and a value of each row group or each column group; and
performing multi-headed self-attention calculation on the first matrix, the second matrix, and the third matrix of each row group, and the first matrix, the second matrix, and the third matrix of each column group respectively.

7. The method of claim 1, wherein receiving the input feature map comprises:
performing space downsampling on the input feature map, to obtain a downsampled feature map.

8. The method of claim 7, further comprising:
performing conditional position encoding on the downsampled feature map, to generate an encoded feature map.

9. The method of claim 8, wherein performing the conditional position encoding on the downsampled feature map comprises:
performing depthwise convolution calculation on the downsampled feature map.

10. The method of claim 8, further comprising generating variable scale features comprising:
adding the downsampled feature map to the encoded feature map, to generate first feature vectors;
performing layer normalization on the first feature vectors, to generate first normalized feature vectors;
performing self-attention calculation on the first normalized feature vectors, to generate second feature vectors;
adding the first feature vectors with the second feature vectors, to generate third feature vectors;
performing layer normalization on the third feature vectors, to generate second normalized feature vectors;
performing multi-layer perceptron on the second normalized feature vectors, to generate fourth feature vectors; and
adding the second normalized feature vectors to the fourth feature vectors, to generate a first-scale feature map.

11. The method of claim 10, further comprising:
determining the first-scale feature map as the input feature map, and repeating steps of performing the space downsampling on the input feature map and generating the variable-scale features; wherein,
in each repeating cycle, the step of performing the space downsampling is performed once and the step of generating the variable-scale features is performed at least once.

12. An electronic device, comprising:
a processor; and
a storage device for storing one or more programs,
wherein the processor is configured to perform the one or more programs to:
in response to receiving an input feature map of the signal, divide the input feature map into patches of a plurality of rows and patches of a plurality of columns, wherein the input feature map represents features of the signal;
select a row subset from the plurality of rows and a column subset from the plurality of columns, wherein rows in the row subset are at least one row apart from each other, and columns in the column subset are at least one column apart from each other; and
obtain aggregated features by performing self-attention calculation on patches of the row subset and patches of the column subset.

13. The device of claim 12, wherein the processor is configured to perform the one or more programs to:
determine a plurality of pales from the row subset and the column subset, wherein each of the pales comprises at least one row in the row subset and at least one column in the column subset;
perform the self-attention calculation on patches of each of the plurality of pales, to obtain sub-aggregated features; and
cascade the sub-aggregated features, to obtain the aggregated features.

14. The device of claim 12, wherein the processor is configured to perform the one or more programs to:
divide the input feature map into a first feature map and a second feature map that are independent of each other in a channel dimension; and
divide the first feature map into the plurality of rows, and dividing the second feature map into the plurality of columns.

15. The device of claim 14, wherein the processor is configured to perform the one or more programs to:
perform the self-attention calculation on the row subset of the first feature map and the column subset of the second feature map respectively, to obtain first sub-aggregated features and second sub-aggregated features; and
cascade the first sub-aggregated features and the second sub-aggregated features in the channel dimension to generate the aggregated features.

16. The device of claim 15, wherein the processor is configured to perform the one or more programs to:
divide the row subset of the first feature map into a plurality of row groups, each row group containing at least one row;
divide the column subset of the second feature map into a plurality of column groups, each column group containing at least one column;
perform the self-attention calculation on patches of each row group and patches of each column group respectively, to obtain aggregated row features and aggregated column features; and
cascade the aggregated row features and the aggregated column features in the channel dimension, to obtain the aggregated features.

17. The device of claim 16, wherein the processor is configured to perform the one or more programs to:
determine a first matrix, a second matrix, and a third matrix of each row group and a first matrix, a second matrix, and a third matrix of each column group, wherein the first matrix, the second matrix, and the third matrix are configured to generate a query, a key and a value of each row group or each column group; and
perform multi-headed self-attention calculation on the first matrix, the second matrix, and the third matrix of each row group, and the first matrix, the second matrix, and the third matrix of each column group respectively.

18. The device of claim 12, wherein the processor is configured to perform the one or more programs to:
perform space downsampling on the input feature map, to obtain a downsampled feature map; and
perform conditional position encoding on the downsampled feature map, to generate an encoded feature map.

19. The device of claim 12, wherein the processor is configured to perform the one or more programs to:
add the downsampled feature map to the encoded feature map, to generate first feature vectors;
perform layer normalization on the first feature vectors, to generate first normalized feature vectors;
perform self-attention calculation on the first normalized feature vectors, to generate second feature vectors;
add the first feature vectors with the second feature vectors, to generate third feature vectors;
perform layer normalization on the third feature vectors, to generate second normalized feature vectors;
perform multi-layer perceptron on the second normalized feature vectors, to generate fourth feature vectors; and
add the second normalized feature vectors to the fourth feature vectors, to generate a first-scale feature map.

20. A non-transitory computer-readable storage medium having stored therein instructions that, when executed by a processor of a mobile terminal, causes the mobile terminal to perform a method for processing a signal, the method comprising:
in response to receiving an input feature map of the signal, dividing the input feature map into patches of a plurality of rows and patches of a plurality of columns, wherein the input feature map represents features of the signal;
selecting a row subset from the plurality of rows and a column subset from the plurality of columns, wherein rows in the row subset are at least one row apart from each other, and columns in the column subset are at least one column apart from each other; and
obtaining aggregated features by performing self-attention calculation on patches of the row subset and patches of the column subset.
